(19) United States
(12) Patent Application Publication
(10) Pub. No.: US 2014/0214895 A1
(43) Pub. Date: Jul. 31, 2014

(54) SYSTEMS AND METHOD FOR THE PRIVACY-MAINTAINING STRATEGIC INTEGRATION OF PUBLIC AND MULTI-USER PERSONAL ELECTRONIC DATA AND HISTORY

(71) Applicant: INPLORE, Boston, MA (US)

(72) Inventors: John M. HIGGINS, Cambridge, MA (US); Vikram S. KUMAR, Boston, MA (US)

(73) Assignee: INPLORE, Boston, MA (US)

(21) Appl. No.: 14/168,242

(22) Filed: Jan. 30, 2014

Related U.S. Application Data
(60) Provisional application No. 61/758,878, filed on Jan. 31, 2013.

(51) Int. Cl. G06F 17/30

(52) U.S. Cl. CPC G06F 17/30442
USPC 707/770

(57) ABSTRACT

In one embodiment, a method of transmitting a directed query from a client device that stores private data elements includes determining relationships between elements of the private data, where each of the relationships associates two or more elements of the private data. The method may further include receiving a query related to a target element of the private data, where the query requests data related to the element that is not present in the private data. The method may further include storing the query in electronic memory. The method may further include determining a recipient for the query based on the relationships associated with the target element of the query. The method may further include electronically transmitting the query to the recipient.

This application claims priority under 35 U.S.C. §119(e) to U.S. Provisional Application No. 61/758,878, filed Jan. 31, 2013, entitled “Systems and Method for the Privacy-Maintaining Strategic Integration of Public and Multi-User Personal Electronic Data and History,” the contents of which are incorporated by reference herein.

### BACKGROUND

The Internet provides access to large amounts of “public” data. Information technology in general has allowed individuals to accumulate and to some extent to curate significant amounts of “private” data.

### SUMMARY

This disclosure describes systems and methods for integrating the “public” data with a set of users' “private” data to (1) allow individuals to accomplish new tasks, (2) to accomplish tasks with significant increases in efficiency and accuracy, and (3) to do so without compromising the privacy of any of users involved.

The present disclosure relates to systems and methods for the strategic and privacy-maintaining integration of public and multi-user personal data to accomplish important tasks. The system can include multiple local client systems running on personal computers or smart phones and server systems running on de-centralized server computers. The system can accomplish tasks for users by analyzing and integrating data that is distributed among the systems. The systems' behaviors are governed by the users' privacy preferences. Local personal data is analyzed by each client system to identify patterns and features that help users accomplish important tasks. Each user has the option of enabling his trusted contacts to benefit from some specified patterns and features of his data. Each user, in turn, may benefit from some aspects of the analysis of his contacts' private data, in accordance with their privacy preferences. The server systems coordinate and facilitate these interactions.

In one embodiment, a system includes local client systems and a server system in communication with the local client systems. The distributed server system routes directed queries between local client systems by receiving queries and transmitting them to their intended recipients. The local client systems store unstructured user data and have a user interface for constructing queries, wherein the queries request particular information. The queries, once constructed, are directed to particular local client systems based on an analysis of unstructured private user data by the local client systems. The analysis of the unstructured private user data identifies patterns and connections for intelligently directing queries. A directed query is a query directed at particular local client systems based on the likelihood that those local client systems will have appropriate data to respond to the query. This determination is based on the analysis of private user data in conjunction with the parameters of the query. In some embodiments this determination can be performed in a distributed manner using local client systems that have given instructions to the server system to forward query parameters of said type. In another embodiment, this determination can be performed using the server system that has received data pushed to it from the local client systems.

In another embodiment, a method for generating and processing a directed query includes (1) indexing and analyzing private user data, (2) running a user query against that user's indexed and analyzed private user data, and, if necessary, transmitting the query to external data sources, (3) processing the query using external data from the external data sources, and (4) either responding to the originating user or redirecting the query to another external data source.

In another embodiment, a client system stores contact data for the client, wherein the data represents traits and occurrences of contact between other users and the client. The client system includes logic for analyzing the contact data to determine the strength of connection between users in contact with the client. The client provides a user interface to receive queries from a user, wherein the queries have an associated category. The client further includes logic to direct the query at target users based on the strength of connection between users and the category of the query.

In another embodiment, a method for running analytics on client data to direct queries includes (1) indexing and analyzing user data to determine data entities, (2) determining the strength of connection between those data entities, wherein the strength of connection is determined based on the user data and public data indicating the degree of relationship between entities, (3) receiving a user query, and (4) based on the determined strengths of connection, directing the query at an appropriate data entity likely to have information responsive to the query.

In another embodiment, a server in communication with client systems stores data describing queries to which those client systems are interested in responding. The server includes logic to receive an anonymized query from a first client system, to determine client systems to forward the anonymized query based on the stored data, and to forward a response back to the originating client. Local client systems store preferences describing queries to which the client is interested in responding, provide a user interface to configure those preferences, and logic to communicate those preferences to the server. Local client systems further store data used to respond to queries and logic to respond to queries using that data.

In another embodiment, a method for sending an anonymized query includes (1) providing a user interface to receive a query from a user, (2) obtaining a response to the query from a server based on data stored by the server, (3) based on the obtained response, transmitting an anonymized query to the server requesting information from other users, (4) the server transmitting the anonymized query to relevant users, based on data stored by the sever, and (5) receiving a forwarded response from the server, wherein the forwarded response includes data from another user based on the anonymized query.

In another embodiment, a system for processing queries using a mixture of public and private data includes a server in communication with client systems. The client system stores private user data, user permissions to share that data, and logic for analyzing the private data to create structured data. The client system also has logic to process queries by analyzing the structured data to determine external data needed to answer queries and request that data from the server using structured data having user permission to share.

In another embodiment, a method for retrieving information includes (1) receiving access to private user data and processing that data into structured data, (2) receiving permission to share elements of that private data with a query routine, (3) the query routine analyzing the shared data and obtaining additional external data to respond to a user query, and (4) generating output in response to the user query based on the shared data and the obtained external data.

In another embodiment, a client system for providing user control and feedback over data exposure stores personal data and preferences regarding elements of the personal data to share. The client system may provide a user interface for selecting elements of the personal data to share and logic for updating the preferences regarding elements of the personal data to share based on user interface selections and, based on each selection, generating and displaying a visualized indication of the level of privacy of the stored personal data. Alternatively, the client system may receive rules that define elements of personal data to share without the need for a user interface.

In another embodiment, a method for providing user feedback and control over data exposure includes (1) decomposing user data into data components, (2) providing a user interface to obtain user selections indicating which data components may be shared with other systems, (3) in response to each user selection, generating and displayed a visualized indication of the level of privacy of the user data, and (4) sharing the selected user data.

In another embodiment, a client system for responding to queries based on private data stores private user data and permissions regarding users whose queries may be processed using this private user data. The client system may be in communication with a server and receive user queries from the server. The client system may also be in direct communication with other broadcasting client systems and receive user queries from those broadcasting client systems. The client system includes logic to determine if the user from which a user query originated has permission for the user query to be processed using the private user data, and, if such permission has been granted, to process and respond to the query using the data.

In another embodiment, a method for responding to user queries using private data includes (1) receiving a user query originating from a user, (2) determining if the user has been configured as a trusted user, (3) if the user has been configured as a trusted user, (3) processing the query using the private data to generate a response, (4) obtaining permission to transmit the response to the user, and (5) once permission has been obtained, transmitting the response to the user.

### BRIEF DESCRIPTION OF THE DRAWINGS

For a more complete understanding of various embodiments of the present disclosure, reference is now made to the following descriptions taken in connection with the accompanying drawings in which:

FIG. 1 illustrates a high-level architecture of a multi-client and server system, according to some embodiments;

FIG. 2 illustrates the method to use the multi-client and server system, according to some embodiments;

FIG. 3 illustrates the system's analytics running on the local client, according to some embodiments;

FIG. 4 illustrates the method to run local analytics on the client in the system, according to some embodiments;

FIG. 5 illustrates the system to send an anonymized query through the server, according to some embodiments;

FIG. 6 illustrates the method to send an anonymized query through the server, according to some embodiments;

FIG. 7 illustrates the system of client-side routines with access to personal and additional data, according to some embodiments;

FIG. 8 illustrates the method that runs the client-side routines with access to personal and additional data, according to some embodiments;

FIG. 9 illustrates a system to give a user feedback and control over data exposure, according to some embodiments;

FIG. 10 illustrates a method to give a user feedback and control over data exposure, according to some embodiments;

FIG. 11 illustrates a system for user configurable automatic client actions; and

FIG. 12 illustrates a method for user configurable automatic client actions, according to some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It may be apparent to one skilled in the art, however, that the disclosed subject matter may be practiced without such specific details, and that certain features, which are well known in the art, are not described in detail in order to avoid unnecessary complication of the disclosed subject matter. In addition, it may be understood that the embodiments provided below are exemplary, and that it is contemplated that there are other systems and methods that are within the scope of the disclosed subject matter.

### Generating and Processing Directed Queries

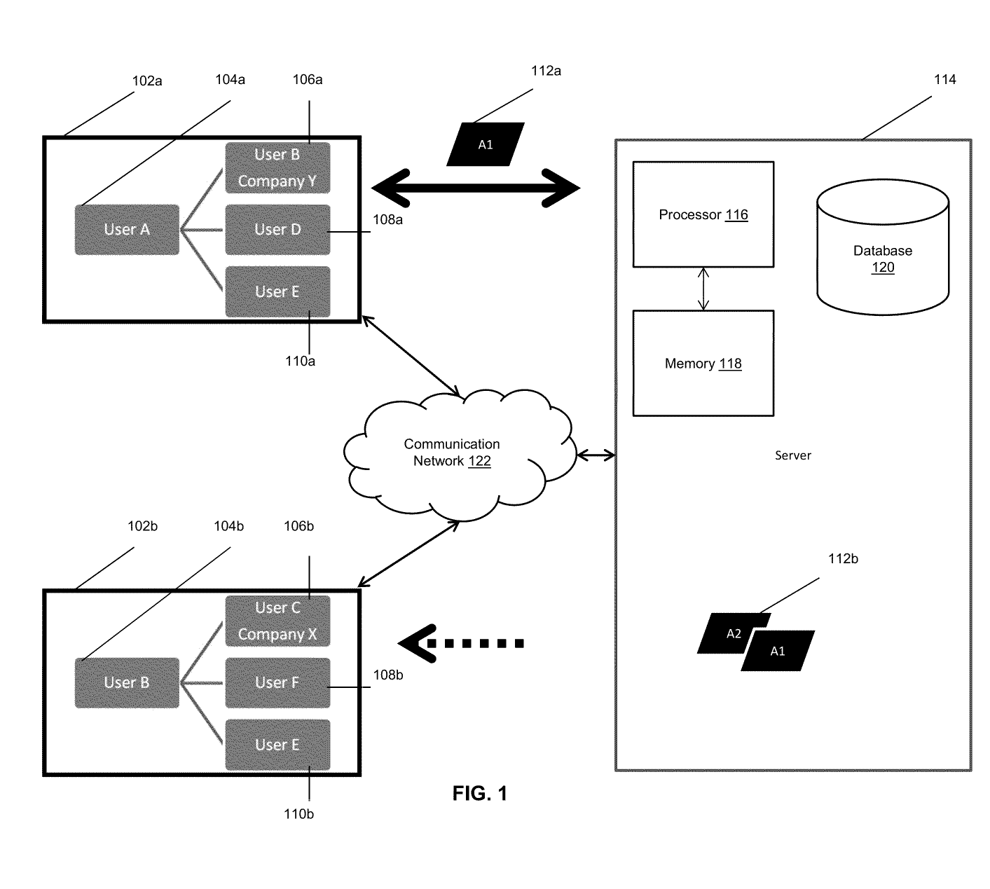

FIG. 1 illustrates a high level architecture of a query processing system, in accordance with some embodiments. The system includes a first local client system 102a, a second local client system 102b, User A 104a, User B 104b, User B and his affiliation with Company Y 106a, User C and his affiliation with Company X 106b, User D 108a, User F 108b, a first User E entity 110a, a second User E entity 110b, a first directed query 112a, a second directed query 112b, a distributed server system 114, a processor 116, a memory 118, a database 120 and a communication network 122. The local client system 102a indexes and analyzes User A's private and personal data in accordance with some embodiments described below. This analysis creates multiple structures which reveal different types of relationships (variable strength, context, dynamics) between User A and the entities (104a, 106a, 108a, 110a) in User A's contact list email history, messaging history, social networking information, and more. In some embodiments, User A's contact list may include User B 106a along with the fact that User B has an affiliation of a certain type with Company Y. The client enables User A to construct directed queries 112a. The queries are directed to other individuals or users based on the client's analysis of the user's private data. The data that describes a user may include, for example, his contacts, the schools that he has attended, and the places that he has lived. This data may be used by the system to facilitate an introduction between two users who are in close proximity and have activated local networking broadcast and receive settings on their local client systems, or who both are broadcasting their location coordinates to the server 114 that realizes they are in close proximity and facilitates an introduction through their respective local clients. These local client systems may then communicate directly using communication network 122. At the server queries 112b flagged as relevant to User B are queued to be pulled by User B. For instance, User A may be interested in information about, insight into, or a connection to Company X to make a sale to Company X. User A relies on the client to construct the query and to transmit it to the distributed server system 114 through the communication network 122. The distributed server system 114 may determine which queries are relevant to users using data that has been pushed to the server from local clients. Alternatively, this determination may be made in a distributed manner by local clients that have given instructions to the distributed server system 114 to forward query parameters of certain types to other clients.

Local client systems 102a and 102b are in communication with the distributed server system 114 through communication network 122. Local client systems 102a and 102b may also be in direct communication with each other through communication network 122. These local client systems may communicate using peer-to-peer techniques known to those of ordinary skill in the art. Server 114 provides routing services for queries and introductions between local clients, and includes a database 120 configured to centrally store policies for routing. Server 114 includes a processor 116 in communication with database 120 and memory 118. Processor 116 is configured to run modules stored in memory 118 (and/or database 120) that are configured to cause the processor to perform computerized functions, further described herein. The illustrated components are for example only, any other number of local client systems, distributed server systems, or other illustrated components may also be used.

Referring to the local client systems 102a and 102b, local client systems 102a and 102b can be, for example, cell phones, PDAs, smartphones, laptops, personal computers, and/or any other type of computing device. Local client systems 102a and 102b can store and access private data including email, social networking information, and documents.

The query 112a encapsulates the curated information of interest to the user as well as a list of intelligently-selected recipients of that query, some of whom may be obscured to User A. For example, it may be unknown to User A that User B 104b has a contact, User C 106b, with an affiliation to the target Company X. While conventional systems to manage contacts or customers may not disclose this connection, User B is an appropriate target or recipient for the query.

The server system 114 receives the query and routes it to the desired recipients, making it available in this case to User B's personal client 102b. User B may manually respond to a query or may have configured the local client to receive queries from a subset of User B's contact list automatically. In another embodiment, User A wishes to perform a confidential business action so may use the system to guide him to vendors that satisfy specified or learned criteria. For example, he wants to rent an office for his growing business, but does not want to alert his competition that he is opening an office in the area. He feeds into the described system the information he knows of his competitors including their business names, business office locations along with the dates on which they may have opened those offices, names of business officers, and investors. His goal is to find a rental agent who has no connection with his competing businesses or any of their closely affiliated contacts. The server system 114 takes User A's data and aggregates information from public sources that relate to the said data that it processes to give User A recommendations on leads (in priority) that he may contact for his goal. The system can also track the queries and subsequent communication to best facilitate his management of this process.

Communication network 122 can include a network or combination of networks that can accommodate private data communication. For example, communication network 122 can include a local area network (LAN), a private cellular network, a private telephone network, a private computer network, a private packet switching network, a private line switching network, a private wide area network (WAN), or any number of private networks that can be referred to as an Intranet. Such networks may be implemented with any number of hardware and software components, transmission media and network protocols. FIG. 1 shows network 122 as a single network; however, network 122 can include multiple interconnected networks listed above.

Processor 116 can be configured to implement the functionality described herein using computer executable instructions stored in a temporary and/or permanent non-transitory memory such as memory 118. Memory 118 can be flash memory, a magnetic disk drive, an optical drive, a programmable read-only memory (PROM), a read-only memory (ROM), or any other memory or combination of memories. Processor 116 can be a general purpose processor and/or can also be implemented using an application specific integrated circuit (ASIC), programmable logic array (PLA), field programmable gate array (FPGA), and/or any other integrated circuit. Similarly, database 120 may also be flash memory, a magnetic disk drive, an optical drive, a programmable read-only memory (PROM), a read-only memory (ROM), or any other memory or combination of memories. Computing device 114 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs.

The components of the system depicted in FIG. 1 can include interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, for example optical, copper, and wireless, and in a number of different protocols some of which may be non-transient.

The software in server 114 can be divided into a series of tasks that perform specific functions. These tasks can communicate with each other as desired to share control and data information throughout server 114 (e.g., via defined APIs). A task can be a software process that performs a specific function related to system control or session processing. In some embodiments, three types of tasks can operate within server 114: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem can include critical tasks, controller tasks, and manager tasks. Some of the subsystems that run on server 114 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of server 114 by monitoring the various software and hardware components of server 114. Recovery control task subsystem can be responsible for executing a recovery action for failures that occur in server 114 and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group may preferably not be affected by that problem.

A shared configuration task subsystem can provide server 114 with an ability to set, retrieve, and receive notification of server configuration parameter changes and is responsible for storing configuration data for the applications running within server 114. A resource management subsystem can be responsible for assigning resources (e.g., processor and memory capabilities) to tasks and for monitoring the task's use of the resources.

In some embodiments, server 114 can reside in a data center and form a node in a cloud computing infrastructure. Server 114 can also provide services on demand such as Kerberos authentication, HTTP session establishment and other web services, and other services. A module hosting a client can be capable of migrating from one server to another server seamlessly, without causing program faults or system breakdown. A server 114 in the cloud can be managed using a management system.

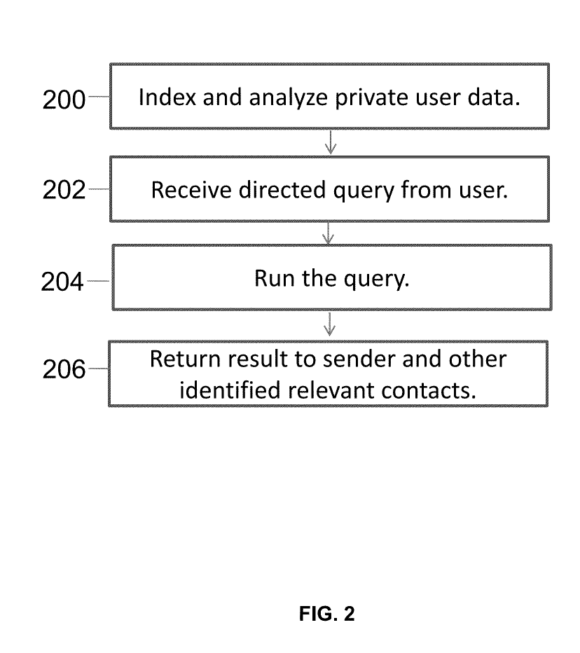

FIG. 2 illustrates a flow diagram of a process for generating and processing a directed query, according to some embodiments. The process may include one or more of the steps of indexing and analyzing private user data 200, receiving a directed query for a user 202, running the query 204, and returning the results to the sender and other identified relevant contacts 206. The first step 200 is to index and analyze private user data. In some embodiments, the indexing and analyzing includes one or more of the following steps: (1) structured user data desired to be indexed and analyzed is loaded to the system, (2) each record loaded (e.g., photograph, document, contact list, emails, search result, etc.) is recognized by the system based on its header, file extension name, or metadata, (3) a routine that indexes data based on its type is run for each record, (4) based on the record type, the indexing routine follows rules to extract features from the data by parsing text, performing image analysis, and doing statistics as applicable, (5) the extracted features are then organized in a database for efficient retrieval, (6) the data is analyzed to find patterns, hidden connections between the records, and perform knowledge discovery. For example, through one or more of these steps, the system may learn that User A has been in many photographs with User T over the years, and has had many email exchanges with both User T and User U; based on this discovery, it may organize Users A, T, and U into a cluster with an especially close pairing between Users A and T due to a system rule that dictates that being in a photograph together implies a close relationship. Other rules for defining the nature and strength of relationships known to those of ordinary skill in the art may also be used. The output of the indexing and analyzing in one embodiment is one database per record type with relations mapped across the structured user data loaded of that record type (e.g., an output database is constructed by analyzing relations across people recognized from the user's photographs loaded to the system). In another embodiment, the output of the indexing and analyzing is an aggregated database for the user of all loaded data that includes contacts (disambiguated) with relations between the contacts (with their strengths of connections), and relations between contacts and other data types. For example, all of the movies watched by a user and his friends may be indexed and organized into a database that sits on the client (or server). The database shows what movies relate to a user, and also how a user and his friends may be fit in a cluster because of the common movies that they watched or common reactions to movies they expressed.

The second step 202 involves a user sending a directed query. In some embodiments, sending the directed query includes one or more of the following steps: (1) composition of the query (as in 112a in FIG. 1) by the user through the user interface, (2) first running the query on the user's indexed and analyzed local personal data, (3) if the query result from the local data gives a partial and suboptimal result or the user chooses to run the query on more data including the personal data of other users, the query is transmitted through the communication network 122 to these other data sources; the query may reach the external data sources through the following ways: (4.1) peer to peer in so much that a query sent by a user directly reaches every other user on the system, it is processed by users based on their privacy preferences (e.g., some users may allow all queries into their client, others may allow none, and others may allow only queries from specified users into their client), (4.2) peer to peer in so much that a query sent by a user directly reaches other users, a user that accepts the query provides the sender with a unique key to use for future queries so they are recognized as friendly by the receiver's client, (4.3) server based in so much that a receiving user pushes lists to the server that include a list of the names of sending users whose queries the receiver may accept, a list of query topics that the receiver may accept regardless of the identity of the sending user (e.g., ‘send all queries from any user on biology and basketball’), and the state of the receiver such as ‘not accepting any queries’, ‘accepting all queries’, and ‘accepting select queries’, (5) the query is sent directly in the peer to peer case, and it is routed via the server based on the server lists in the server case. An example query may be ‘seeking connection to Company X’, or ‘tell me if you think Company X a good employer.’

The third step, 204, runs the query on the sending or receiving user's data. In some embodiments, running the query includes one or more of the following steps: (1) parse the query, (2) apply stemming to the query terms, (3) apply a lexical database to find words such as synonyms that relate to the query, (4) use the following algorithm:

Result=Search for (QT1,QT2,w1*RT1,w2*RT2 . . . )

where QT1, QT2, . . . QTn are the parsed query terms, RT1, RT2, . . . RTn are related terms such as synonyms to the query terms, and

w1, w2, . . . wn are weights applied to related terms. These weights can be calculated from an analysis of the strength of the semantic relationships between the terms. The weights also can be optimized through unsupervised learning algorithms. Other machine learning and data mining techniques can be used to conduct the search through the indexed and analyzed local data. The result may be objective and based on knowledge present in the receiving user's personal data (e.g., to ‘What is your mailing address?’, result may be ‘100 Main Street, Any Town, USA’), it may be objective yet not located in the receiver's data and hence is redirected in step 206 to an appropriate other contact (e.g., ‘What is the visa requirement to work in Turkey’, may be redirected to a contact from Turkey), it may be subjective and answerable by the receiving user or anyone to whom it is redirected (e.g., ‘What is the best introductory quantum computing book?’).

The fourth step, 206, returns the result to the sending user. In some embodiments, returning the result includes one or more of the following steps: (1) determine the quality of the query result through rules that consider metrics such as the number of search results to the query and related terms, (e.g., a user may have no results to a query about ‘vinyards’), the number of times the same query had to be redirected by the receiving user to a more relevant user, (2) determine the strength of connection between the receiving user and the sending user and the level of formality and hierarchy in the relationship based on structure in the data or learning algorithms, (3) measure the strength of clustering of the receiving user's other contacts (and associated tags) around the query and related terms, (4) based on the above metrics and rules specified by the receiving user, either return the result to the sending user, or redirect it (with an appended message) to another contact identified as appropriate through the clustering analysis.

### Targeting a Directed Query by Running Analytics on User Data

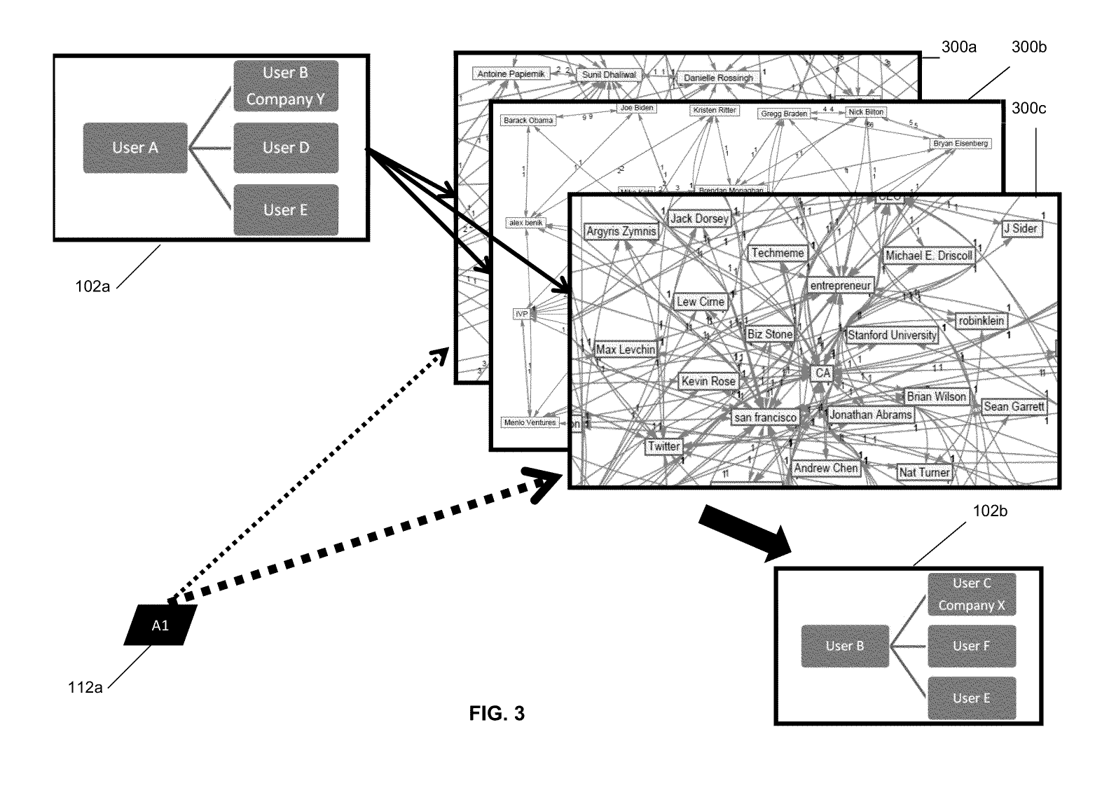

FIG. 3 illustrates a system for running analytics on a local client system to generate a directed query to be directed to another local client system, according to some embodiments. The system includes a first local client system 102a, a second local client system 102b, a directed query 112a, a first graph of nodes with weighted connections 300a, a second graph of nodes with weighted connections 300b, and a third graph of nodes with weights connections 300c. User A enables his client 102a to analyze and index private data, including, at his option, for example, contact lists, email histories, messaging histories, web browsing histories, social networking information, usage statistics on data, history of sharing pieces of data with particular people, and more. In some embodiments, none of this analysis leaves the user's local environment. In another embodiment, the local client system creates an index or cache of all of the user's local data including views of the data that may include images created of files, compressed documents generated that summarize the files, graphs that describe how the files relate to other pieces of data, and other ways to capture elements of the user's data that may be presented to a user to help the user recall the context of the data, its potential use and sensitivity.

The client 102a uses machine learning algorithms to calculate the “strength of connection” between individuals in User A's private network based on one or more distance metrics. For example, one metric for strength of connection is the frequency of interactions between the individuals, with more frequent interactions associated with a stronger connection. Another metric is the rate of change in the frequency of interactions, with increasing frequency associated with stronger connection, and decreasing frequency associated with weaker connection. A third metric is the number of traits or characteristics shared between individuals. In some embodiments, the machine learning algorithms takes the following data as input: email message frequencies between two specific users, social media hit frequencies by one user against another, keyword frequencies in email histories or web page caches, number of shared contacts or keywords between two users. The algorithms may also take as input the rate of change over time of these different input sources to describe the dynamics in the relationships between entities (such as a measurement of the decay in a relationship between two entities). For example, the input can be the difference between the email frequency over the past month and prior month, or the cardinality of a keyword in web page histories from the past week divided by the cardinality from the prior week. The algorithms may also take as input the integration of these input data sources over specific intervals of time, for example, the total count of a particular keyword in web page histories over the past 3 weeks or 3 months or the total number of emails between two users over the past 1 week or the total number over the past month. In some embodiments, the elements of this input data may form the nodes in a graph like 300a, 300b, or 300c.

In these and some other embodiments, the machine learning algorithm can include one or more of the following steps: (1) all input data is loaded and indexed to allow rapid re-analysis, (2) a series of data structures, including incidence matrices and adjacency matrices, are built to quantify the strength of connection between pairs of nodes; and (3) each query is categorized, with each query category having a set of weights quantifying the relevance of each input data type. In some embodiments, this algorithm outputs the following results: a weighted average of the distance between the user and each of his contacts, with the set of weights determined by the query category. The different weights between a query and a network of distances are depicted as dotted lines with different strengths in FIG. 3. For example, each metric can be applied to a user's network of contacts and may result in a weighted adjacency matrix, which can be depicted as a network of nodes with weighted connections 300a, 300b, 300c. If the user is searching for advice on good movies to watch, those users who have more similar movie-watching history may be weighted most highly. If the user is looking for information on a particular person, such as a good gift idea, the weighting may reflect the user's strength of connection to the target person.

The User may thus use the client 102a to construct query 112a. The client may categorize the query using classification algorithms and logic. In some embodiments, the classification may be done based on keyword-matching and keyword frequency. In other embodiments, the classification may be done manually by the user by selecting user interface elements or automatically based on the state of the user's client and which client elements have been loaded. The query's classification may inform the selection of appropriate connection strength metrics, for example a restaurant or movie recommendation may be classified as a social or recreational query. A job or sales inquiry may be classified as a work-related inquiry. The client may then intelligently synthesize a weighted combination of networks 300a, 300b, 300c appropriate for the query's context. For instance, frequency of email interactions may be an appropriate metric when deciding whom to ask for movie recommendations, while shared educational or corporate affiliations may be more appropriate for job search inquires. A weighted combination of multiple metrics may be used in most cases to generate a meta-network of the user's contacts. This meta-network may then be used to select the most appropriate recipients for the query. In some embodiments, these recipients may most likely both to be in a position to provide the information or service requested and to make it a priority to respond to the user initiating the query. The result of the analysis may be that User B is the best recipient for the query, which can be then sent to User B's client 102b.

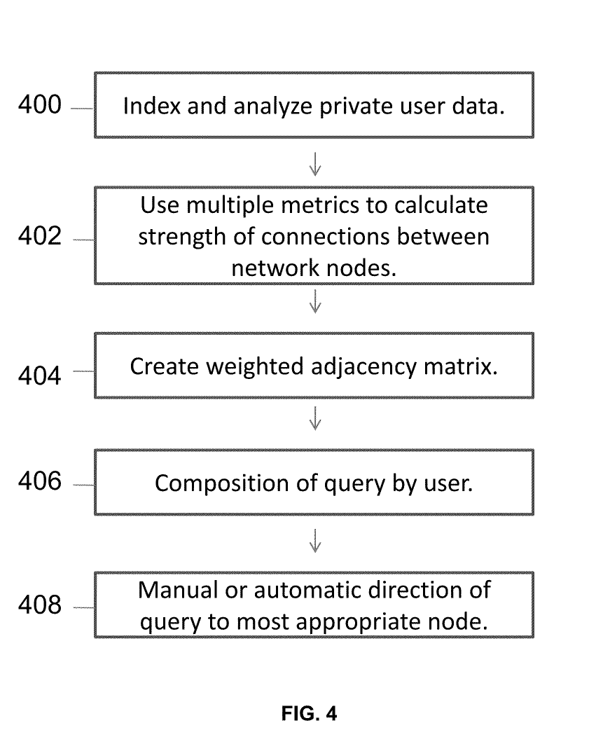

FIG. 4 illustrates a flow diagram of a process for running local analytics on a client in the system, according to some embodiments. The process may include one or more of the steps of indexing and analyzing private user data 400, using multiple metrics to calculate strength of connections between network nodes representing entities in the user data 402, creating a weighted adjacency matrix based on the metrics 404, receiving a composed user query 406, and directing the query to the most appropriate node 408.

The first step 400 can be to index and analyze the user's private data. In some embodiments, the system may index and analyze a user's private data through, for example, one or more of the steps described in 200 of FIG. 2. Next, 402, multiple metrics may define the strength of connection between network nodes. In some embodiments, multiple metrics may define the strength of connection between network nodes through one or more of the following steps: (1) examine the indexed and analyzed user data to determine the types of data available to create the metrics (e.g., to determine the strength of connection between two colleagues, the user's data may not have any social network or personal email data on the pair; the metrics that can be applied may be informed by data showing that the pair has email addresses at the same domain and are colleagues), (2) fetch data from the following private (data that may not have been indexed, for example) and external sources as applicable: public records, web sites and web searches, social network data, private emails, user generated tags through the user interface, applications, transcribed manuscripts, oral notes, and videos or photographs, (e.g., knowing the above pair are colleagues, the system may fetch external data on their company to learn that their company has only 80 employees, thus giving data for a ‘co-worker familiarity likelihood metric’; the system may further apply data mining techniques to analyze published data by the company to find more information on the pair (e.g., the two colleagues may be listed on the of website or the annual report, giving further information on the division of the company and city in which they work)), (3) calculate a frequency of interactions metric for a user and a contact through an analysis of, for example, the following data sets: the user's emails, text messages, phone call records, social network data, photographs, shared expenses between the user and contact gathered from a credit card bill or dedicated expense management application, calendar data showing meetings where the user and contact are both present, public data showing common speaking engagements by the user and the contact, data showing common conference attendance by the user and the contact), (4) calculate a change in frequency of interactions by performing a derivative on the above metrics, and (5) calculate a strength of connection metric based on the number of similar traits between two contacts through an analysis of, for example, the following: emails showing the two contacts have common friends, social network data, demographic data from user entered tags or learning algorithms, contact list data giving address and phone number information to determine if the contacts live nearby one another, search for common interests through an analysis of topics discussed with both contacts via email and other messages, club memberships, events attendance, public donations, analysis of family holiday letters, memberships on boards of companies, social network data showing support by the contacts for particular sporting teams, movies watched, shopping histories, family analyses, professions, voting histories and other data on political preferences, private life events such as previous divorces and lost family members, immigration status, and languages spoken.

Then, 404, a weighted adjacency matrix and incidence matrix can be computed based on the multiple calculated metrics. In some embodiments, a weighted adjacency matrix can be constructed based on the above calculated metrics through one or more of the following steps: (1) determine based on prior data, user tagging, or machine learning the nature of relationship between two nodes in the network, (2) apply weighting factors according to the type of relationship (e.g., paradoxically, frequency of interaction data from email may be sparse in family members who co-habituate as they do most of their communication live, thus strong weightage may be given to the metric showing that they do in fact live at the same address), and (3) compute an adjacency matrix using known techniques.

Finally, a user composes a query 406 that, based on the analytics described above, is directed, 408, to an appropriate node off the adjacency and incidence matrices.

### Selectively Sending Anonymized Queries

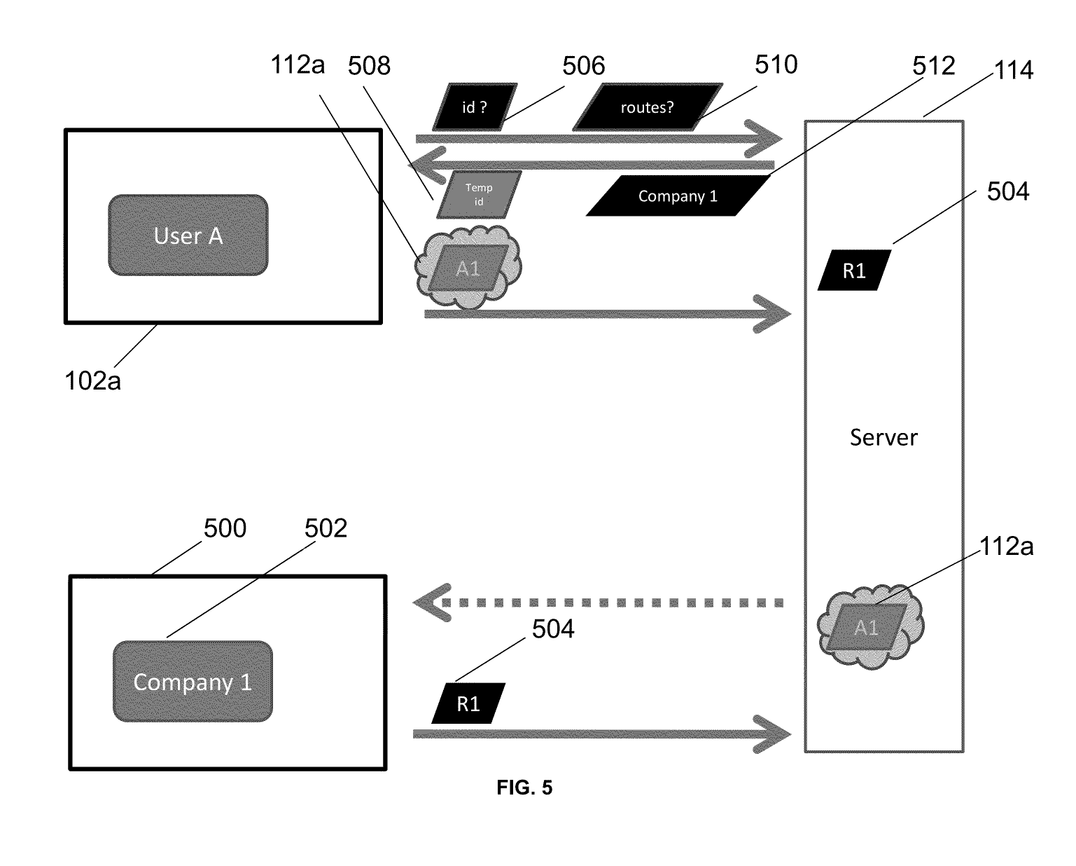

FIG. 5 illustrates a system for sending anonymized queries, according to some embodiments. The system includes a first local client system 102a, a directed query 112a, a distributed server system 114, a second local client system 500, an owner of a second local client system—Company 1 502, a query response 504, a request for an anonymizing ID 506, an anonymizing ID 508, a request for relevant recipients for the query 510, and the routing address of a relevant recipient 512. User A can use the system to anonymize requests before they are presented to other users. For instance, a user may be interested in receiving price quotes on an intended product purchase, but does not want to share any personal or demographic information. As a first step the user may request a new ID 506 that could be used for transmitting the query. The new ID may not be otherwise associated with the user, and depending on the communications protocol could include an email address, an entity address (e.g., an XMPP address also known as a Jabber Identifier), a social media account (e.g., TWITTER account), a phone number, and any other such applicable identifier used for transporting the query. The server 114 may programmatically generate a new ID 508 upon receipt of request 506, by, for example, registering a new email address, Jabber Identifier, Twitter account, phone number, or other as applicable.

Upon receipt of the newly generated ID 508, the client system 102a may accept it as an identifier for use in anonymous communications. In this case, the user may choose to use ID 508 when communicating with a single or set of other users. The user may also choose to use the ID only once, or a number of times. In this way, the user can communicate with a recipient once, and then destroy the ID that was used, so the recipient may not be able to attempt to reengage, send unsolicited messages, or in any other way use that channel to contact the user. The client system could also link the various IDs generated for its use, so that the incoming data could be aggregated, but utilize the IDs for outgoing communication according to the user's selection to maintain the desired level of anonymity.

To control the privacy of the user, the system may send queries only to relevant recipients, rather than as a broadcast to all possible recipients. To do this, a user may send a request for routes 510, including a query string that has terms relevant to the user's intention. Based on the intention of the user, the server 114 may search through its available database and subscriptions to determine the most appropriate recipients. The communication addresses of those recipients 512 may then be sent to the user's client system 102a. The same server 114 may perform the routing functions and the communication functions. Alternatively, more than one server may exist. For example, one server may search available data to find the most appropriate routes, and another server may broker the communication between the user and recipient.

In the case of a vendor 502, the vendor's client may provide the information requested 504 automatically and without knowing who requested the information. Responses 504 may be sent to the anonymized ID 506. The vendor 502 may interact with the user 102a using a local client 500, but it not required to do so. Instead it is possible to upload routing content to the server 114 and subscribe with an email or other addressed used for communications.

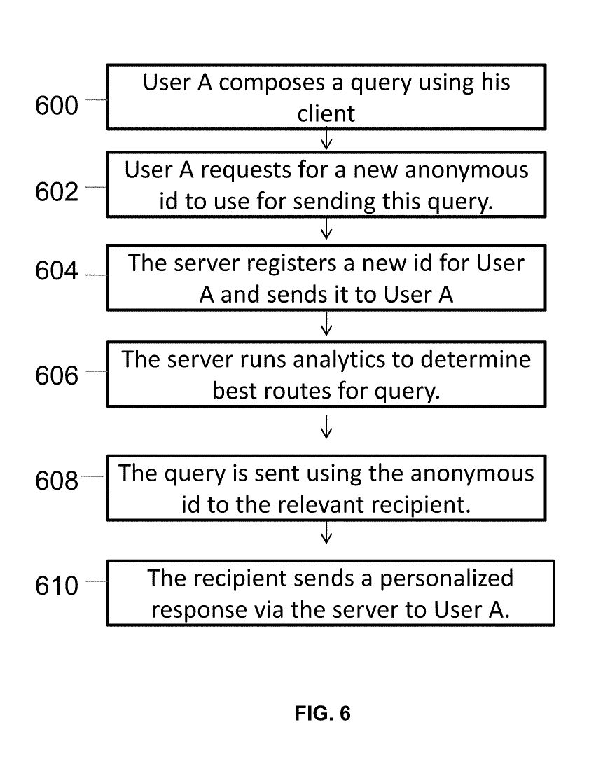

FIG. 6 illustrates a flow diagram of a process for sending an anonymized query, according to some embodiments. The process may include one or more of the steps of receiving a composed user query from a client 600, receiving the results of the query from a server 602, refining and anonymizing the query 604, transmitting the refined and anonymized query to a relevant user 606, and receiving a personalized response to the refined and anonymized query 608.

First, 600, a user composes a query using his client. In some embodiments, a user composes a query through one or more of the following steps: (1) enter main query terms (e.g., ‘buy car’), (2) based on logic in the system and the use of techniques such as natural language processing, related terms are suggested to the user (e.g., ‘new/used/0 down financing/lease/sedan’), (3) based on the personal data of the user that has been made accessible to the system such as the user's web search history, recent credit card transactions, credit score, location of residence, frequent flyer programs, other relevant terms are suggested to the user, (4) the recommendations made by contacts or contacts of contacts on the user's query topic are presented to the user (e.g., ‘Your friend recommends the new S2 sedan’), and (5) the contacts who are related to the query terms (e.g., ‘NK works at YZ motors’) are shown to the user so the user may ask one or many of them questions on the query.

Next, 602, query results from the server are presented to the user. In some embodiments, the query results may be presented through one or more of the following steps: (1) users on the server, including vendors to products being sought, have loaded search results to the server or have connected the system server to their internal query engines for access to search results data, and (2) while a user is composing a query, or upon completion of query composition, results that match the query and related terms are presented to the user, (e.g., the 0 down financing option cars by YZ motors that are available in the user's residence area are shown).

Next, 604, the query is refined and anonymized. In some embodiments, a user finds the results through 602 acceptable as is or after some iterative querying, and then proceeds to act on the presented data, by possibly contacting a vendor or user that generated the results data or is closely associated to the same. In some embodiments, the user has not found an acceptable result and chooses to send the query to the server so that a user (e.g., the YZ Motor Company) may send a personalized response (e.g., special financing terms for a new car based on the user's profile) to the user. In this case the query may be refined and anonymized through one or more of the following steps: (1) the user may refine the query and related terms based on the results sent from the server, and (2) in order to comfortably share personal data with the server, the user's query is anonymized using anonymization algorithms. In some embodiments, knowing that his query may be anonymized, a user may be comfortable sharing his verified credit score to the server to help generate more personalized and possibly more favorable query responses.

Next, 606, the query is sent to the server to reach relevant users on the server. In some embodiments, the query may reach relevant users through one or more of the following steps: (1) users that have subscribed to listen to the server (referred here as relevant users) provide query terms that relate to their interests, (2) these query terms may be purchased by the relevant users based on their profile with pricing that depends on the popularity of the search terms, (3) the system may suggest queries that relate to the relevant users, even if the relevant users have not specifically purchased or signed up for specific query terms, based on machine learning and data mining on available data that maps the interests of the relevant users (e.g., the system maps ‘cars’ to YZ motors), and (4) queries are routed accordingly to relevant users via the server.

Next, 608, the relevant user sends a personalized response via the server to User A. In some embodiments, a personalized response may be sent through one or more of the following steps: (1) a relevant user receives an anonymized query that includes profile data on the sending user (User A) but does not identify the sending user, (2) the relevant user runs the query on its own data to find results that may include offers and deals, and (3) the relevant user creates a personalized response to the query taking into consideration the available data on the sending user (e.g., a response from relevant user YZ Motor Company may be ‘Thank you for your interest in purchasing a car. Given the weekly spending you do on gasoline, along with IJK Gasoline Company in your area, we are able to offer the S2 sedan at $MM/month with 0 money down if you fill at least $m a month in gasoline from IJK. Respond if you would like more details.’). These responses can be generated manually, semi-automatically, or automatically by the relevant users.

### Processing a Query Using A Mix of Private and Public Data

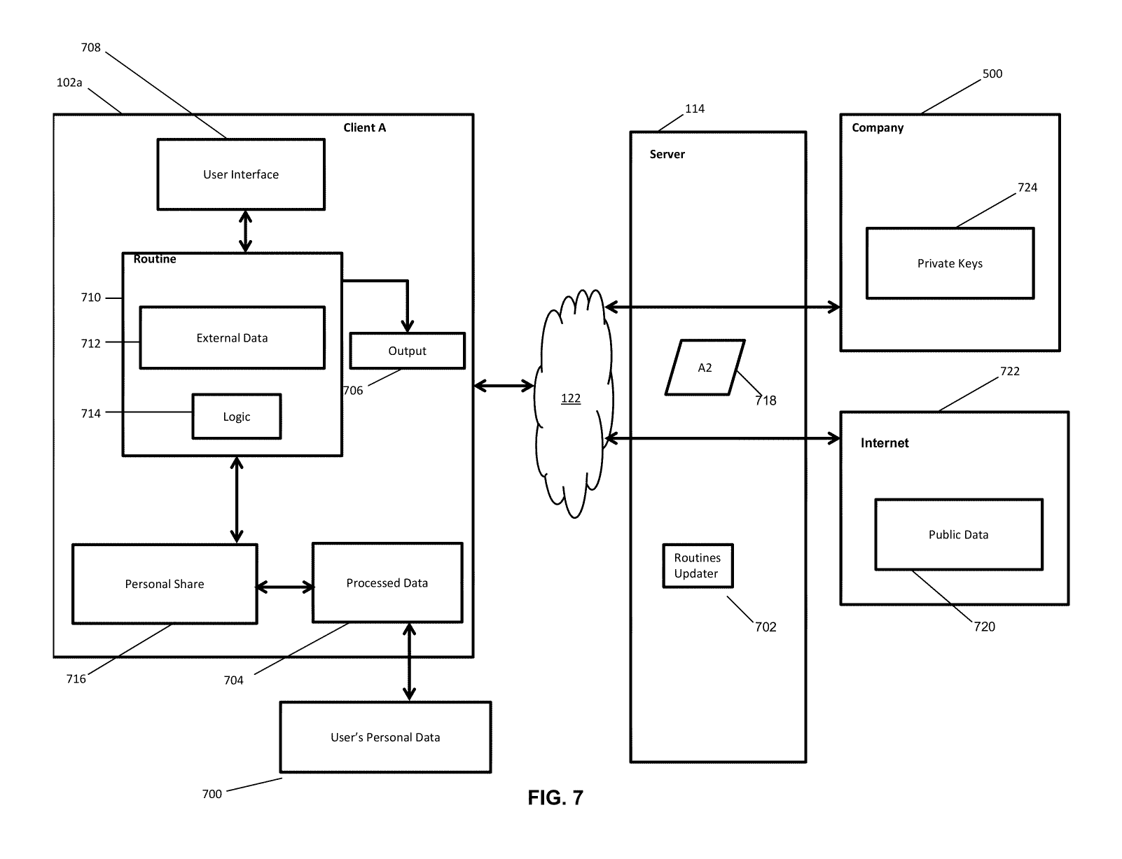

FIG. 7 illustrates a system for processing a query using a mixture of personal and external data, according to some embodiments. The system includes a local client system 102a, a distributed server system 114, Company 500, personal data 700, routine updater 702, processed data elements of the user's personal data 704, routine output 706, user interface for configuring the sharing of data 708, client-side routine for achieving a client objective 710, external data 712, logic for determining data for the routine to use 714, personal data to be shared 716, query 718, public data 720, the Internet 722, and private keys regarding the Company 724. A first step in using a client-side routine is for the user to give the client access to the user's personal data 700 that may be located across his or her local machine, a remote server, a cloud hosted service, third party applications, or others. Access to the data may be provided through authorization standards such as OAuth for web-based data and native file system access via the operating system. The personal data is then processed such as through encryption or decomposition into data elements 704 by the client. The decomposition is based on the inherent structure in the data that in some embodiments, is learned by reading the data schema, and in another embodiment is inferred through machine learning and data mining techniques, and in a further embodiment is described through user input. In some embodiments, the data may be decomposed through one or more of the following steps: (1) look for any metadata describing the structure of the data, (2) find the source of the data, (3) based on source of data, search for the data description (e.g., a credit card statement is a data source with a known structure to its data), (4) if the structure of the data is ambiguous, perform natural language processing, text mining, entity relation extraction, sentiment analysis, and other machine learning and data mining techniques to infer the structure, and (5) organize the data according to the structure, for example, source.filetype, source.filetypeidentifier, identifier.rownumber.field1 . . . fieldn.

The routine 710 has an objective and knows what types of data may be used to achieve the objective. For example, a routine may be designed to guide a user to previous restaurants that the user has visited while traveling. It may not only use knowledge on the restaurants visited by the user (that can be extracted from a credit card statement), but also updated information on whether the restaurants are still open, and their hours of operation. These latter pieces of data do not reside in the user's personal data set, and thus may be pulled from other external data sources. The routine 710 may be triggered by the user through the user interface 708, based on a schedule set by instructions in its logic 714, or by external events such as an incoming email. For example, an incoming email feed from a trusted news source could trigger the routine to fetch corresponding external data and present it on a website for the user.

The routine 710 sits on the local client 102a and has logic 714 that includes a set of instructions that tells it which data to pull based on the data that has been shared with it 716, the routine's objective, and where to run the query 718. For example, if a user wants to visit previously enjoyed seafood restaurants in a particular location, the routine may use data that can identify a restaurant as being a seafood restaurant as well as location data. This data may come from a public or 3^{rd} party data source that includes all restaurants by type. Through the user interface 708, the user allows the sharing of specific data 716. If the user has shared the names of restaurants visited off the user's credit card statement, the query can be run on the server 114—where a simple match against a remote database may be able to determine which of the names provided correspond to seafood restaurants. Hours of operation and directions can be similarly determined for any matched seafood restaurants. The routine 710 receives regular updates 702 off the server 114 to stay current with available public data sources and other relevant released routines.

The routine generates a query 718 that pulls the relevant external (public, in this case) data 720 off the Internet 722 via the server. In the example, if the user did not share the restaurant names with the routine for possible concerns of data privacy, the query may fetch a database of all seafood restaurants and run the query on the local client, not the server. This may maintain the desired level of privacy for the user.

The routine generates an output 706 using the personal data shared 716 and matched external data 712. For example, it may show the user the 5 seafood restaurants she has visited over the past 2 years that are still in business including their hours of operation. It may show the user the previous bill amount at each restaurant. The user may select a restaurant that is added to her itinerary and navigation system. The output may be shared with particular people. It may be put on the server so anyone can see it. It may be integrated with existing applications or imbedded in a 3^{rd} party recommendation engine, for instance. In the same way that external data came from the Internet, this data can come from another client.

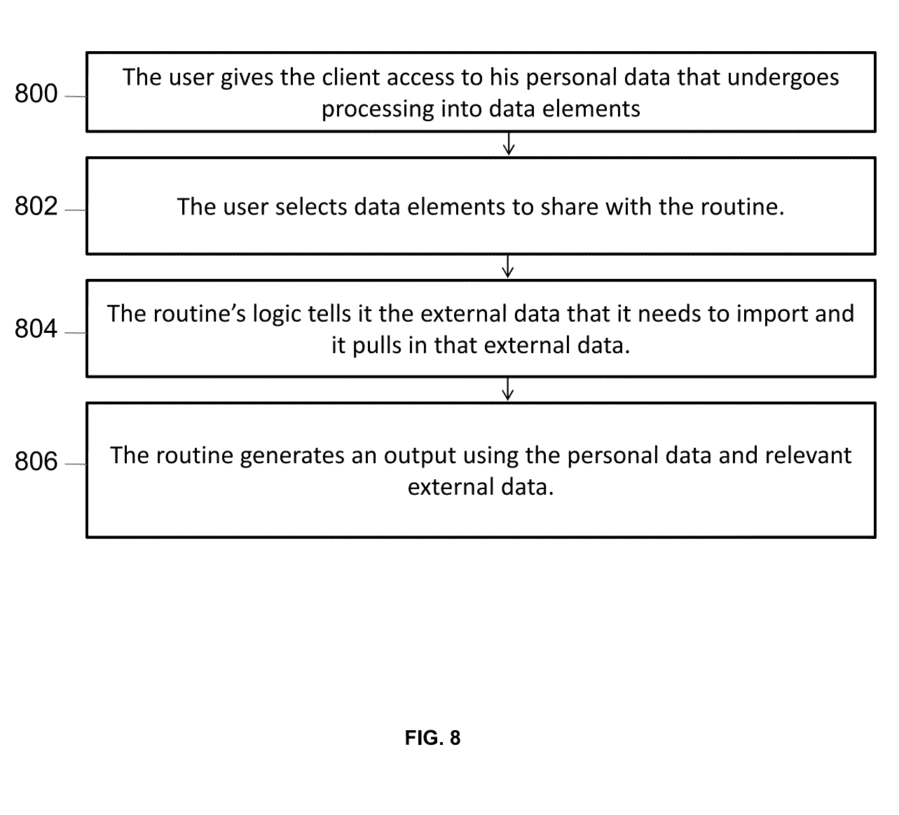

FIG. 8 illustrates a flow diagram of a process that runs client-side routines to retrieve information with access to personal and additional data, according to some embodiments. The process may include one or more of the steps of receiving a user's permission to access his or her personal data for processing into data elements 800, receiving user selection of data elements to share with the routine 802, determining which external data to import into the routine 804, and generating an output based on the personal data and relevant external data 806. First, 800, the user gives its client access to its personal data that is decomposed into component data elements. In some embodiments, the user may give its client access to its personal data that is decomposed into component data elements according to one or more of the following steps: (1) the user shares a folder, provides file paths, or uploads the personal data to the client, and (2) algorithms decompose the personal data by following a data description provided in certain structured data sets, inferring the structure of data based on learning from similar data previously handled, or applying machine learning and data mining techniques to extract the structure of the data.

Next, 802, the user selects the data elements she wants to share with the routine. In some embodiments, the user selects the data elements that she wants to share with the routine according to one or more of the following steps: (1) view the field from the data decomposition (e.g., credit card statement—date of purchase, vendor, item purchased, amount), and (2) select a set of field to share with the routine. This helps the user maintain privacy by not sharing all decomposed personal data with the routine that, though running locally on the user's client, may have been written by a third party (e.g., a restaurant chain) and does not have the user's complete trust.

Then, 804, the routine uses its logic to determine what data it may obtain beyond the personal data shared by the user, where the query may be performed (on the client or the server, for example) to complete the objective of the routine, and proceeds to pull in that external data. In some embodiments, the routine decides the additional data it may use to achieve its objective through one or more of the following steps: (1) determine whether the query is to be performed on the client or the server based on the type of data used for the query and the user's security preferences. If sensitive personal data is to be used, the query may be run in the privacy of the client. This helps ensure that no sensitive data leaves the user's client. In this case, the routine may bring to the client external data instead of sending sensitive data to the server where the external data may already be present. For example, the user may not want to share any personal data with the server but does want to find seafood restaurants previously visited. The user is willing to share her location of interest with the server. The server then pulls the names of all seafood restaurants in that location from the Internet and other databases, and pushes that data to the client. Then in the privacy of the client, the routine can take the names of the restaurants visited by the user and classify them as being seafood restaurants or not. (2) The routine follows its logic to decide if further external data may be used to complete the objective. For example, the routine's logic tells it that the hours of operation of restaurants are not locally available, and hence that data may be pulled from external sources. (3) The routine finally brings the external data through the server, from the Internet, and from other users in a peer-to-peer fashion.

In some embodiments, data is pulled in from other users via mobile devices carried by the users. The user that is requesting data is broadcasting this request using Bluetooth, Near Field Communication, triangulated WiFi signals, and other communication technologies that allow those in the user's vicinity to receive the request, and decide to respond. In some embodiments, a user receives external data in this way from one user, and shares it with other users as he or she travels through space. This is a means for data such as breaking news to travel through a population from one user to another. It is also a means for a user to arrive at a location and instantly receive an update from others in the area on the events going on in the area. In another embodiment, two users have pushed specific data to the system server to be shared with anyone with similarities in their vicinity. The system recognizes that both of the users have strong similarities, including having graduated from the same high school. When the two users are co-located, the system notifies them on their mobile devices to facilitate their networking and people discovery.

Finally, 806, the routine generates an output that is based on the personal data and matched additional (for example public) data. In some embodiments, the routine generates such an output through one or more of the following steps: (1) pull the personal data relevant for the routine, (2) pull the external data used by the routine, (3) perform any transformations of either data set to make them relevant to the desired output, and (4) generate the output.

### Configuring the Privacy Level of User Data

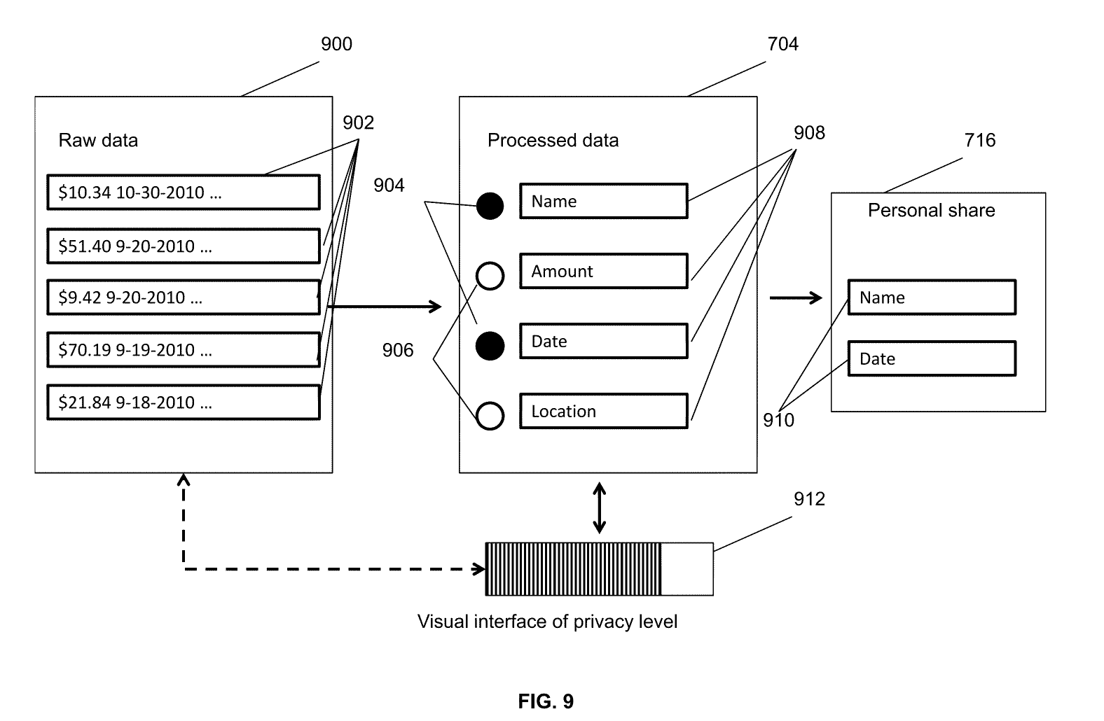

FIG. 9 illustrates a system to give a user feedback and control over data exposure, according to some embodiments. The system includes processed data 704, personal data to be shared 716, data set 900, raw data 902, a user interface to select which fields of the processed data to share 904, which fields of the processed data to protect 906, and descriptions of the fields 908, selected data fields 910, and a visual interface for giving feedback to a user on the privacy level of the data selected to share 912. A data set 900 with raw data 902 is transformed into a new data set 704 with its metadata components or fields that describe components of the data 908. Using a computer interface, a user can see the fields and select which fields to share 904, and which fields to protect 906.

The system may include visual interface 912 that gives feedback to the user on the privacy level of the data selected to share. This may guide the user in choosing which metadata components to share, and also give feedback on the privacy of the raw data set 900 as a whole, or after specific data elements are removed directly from the raw data. In other embodiments, the system may accept rules from a user that define the data to share. For example, a user may specify a rule to exclude from sharing any personally identifiable data.

The data that is being selected 910 has the visualized privacy level 912, and may now be shared 716. For example, after performing these steps, data may be passed to a routine, shared via email with another user, etc.

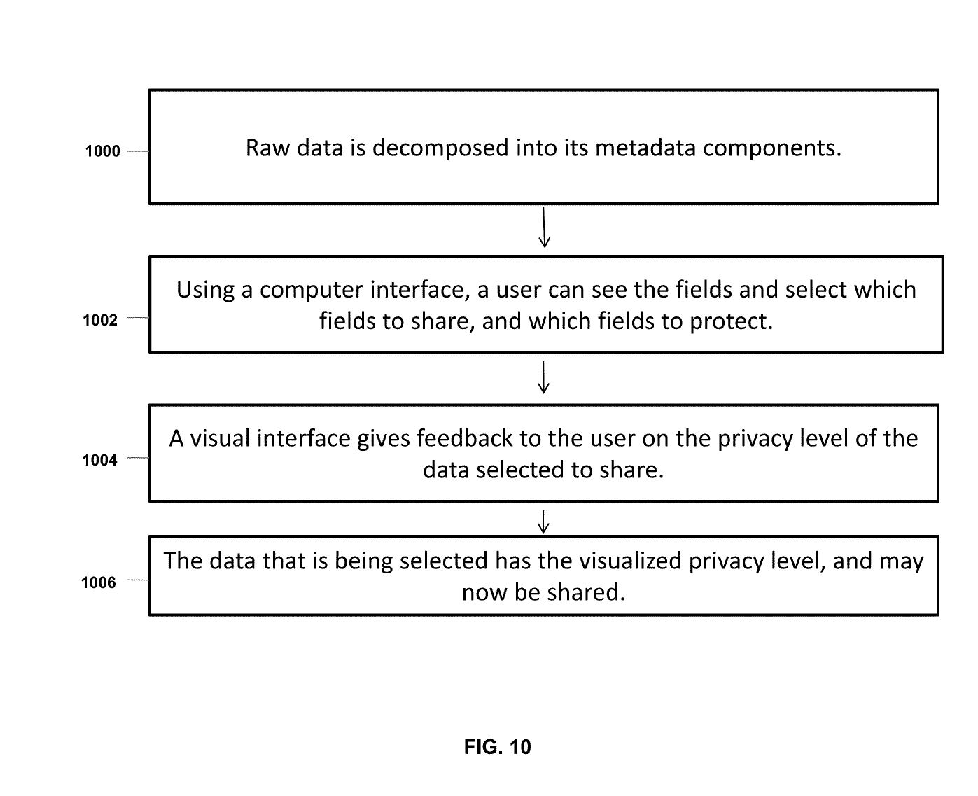

FIG. 10 illustrates a flow diagram of a process to give a user feedback and control over data exposure, according to some embodiments. The process may include one or more of the steps of decomposing raw user data into its metadata fields 1000, providing a user interface in which a user can select which fields to share and which fields to protect 1002, providing feedback to user on the privacy level of the data selected to share 1004, and sharing the data selected to be shared 1006. First, 1000, raw data is transformed or decomposed into its metadata components. In some embodiments, a data set may be decomposed into its metadata fields through one or more of the following steps: (1) load the data set into the system, (2) if the structure of the data is known, organize the data according to the metadata fields (e.g., a user's credit card statement is loaded into the system. The data is divided according to the metadata fields 908—name (of vendor), amount (of transaction), date (of transaction), and location (of vendor). The data may be further decomposed by, (3) if the structure of the data is not known, applying machine learning and data mining techniques to discover patterns in the data that allow the data set to be organized according to its metadata components. In a simplification, if all the data of a data set is represented in a grid, each unique data entry may fit into a row, and each row may be divided into a number of columns. Each column may represent a field that describes a data element present across all entries.

Then, 1002, using a computer interface, the user chooses which components to share, and which to protect. In some embodiments, a user can choose the fields to share through one or more of the following steps: (1) view the data set organized according to its component fields, (2) select the fields wished to be shared with particular applications or parts of the system, (3) the non-selected fields are protected and not shared with any further part of the system. For example, a user may decide to share the names and dates of credit card transactions with the system, but not share the amounts or locations where the transactions were made. In a further embodiment, a machine selects the components to share based on instructions or an understanding of the objective of a routine and what data may be used to reach it. In a yet further embodiment, a user selects some components of the data to share and is assisted by a machine that replicates those actions, or follows other instructions through the rest of the data set.

As the user is selecting the data components, a visual interface may give real time feedback on the privacy level of the data selected to share 1004. In some embodiments, a user may receive real-time feedback on the privacy level of the data selected to share through one or more of the following steps: (1) the privacy level of the data selected to share is determined according to knowledge about the data, rules created by the user or the system, algorithms that learn what types of data the user tags are being sensitive (e.g., a rule in the system dictates that a social security number is a sensitive piece of data), (2) a visual interface shows a representation of a minimum and maximum privacy level (e.g., there may be 5 bars on the visual interface, when all five bars are dark the privacy level is highest while when none of the bars are dark, the privacy level is lowest), and (3) as the privacy level is visually updated while the user is selecting data to share, the user may edit the selections to avoid an unintended selection of data (e.g., if a user selects to share his or her social security number, the privacy level of the data may drop to zero bars. Seeing that, the user may edit the selection).

Finally, 1006, when the selected data is of the desired privacy level, the user may choose to share it. In some embodiments, a user may view a desired privacy level and share the data through one or more of the following steps: (1) view the privacy level, and (2) refer to rules explicitly defined by the user, learned by the system, or defined at that time to share data with an acceptable privacy level.

### Configuration of Trusted Contacts

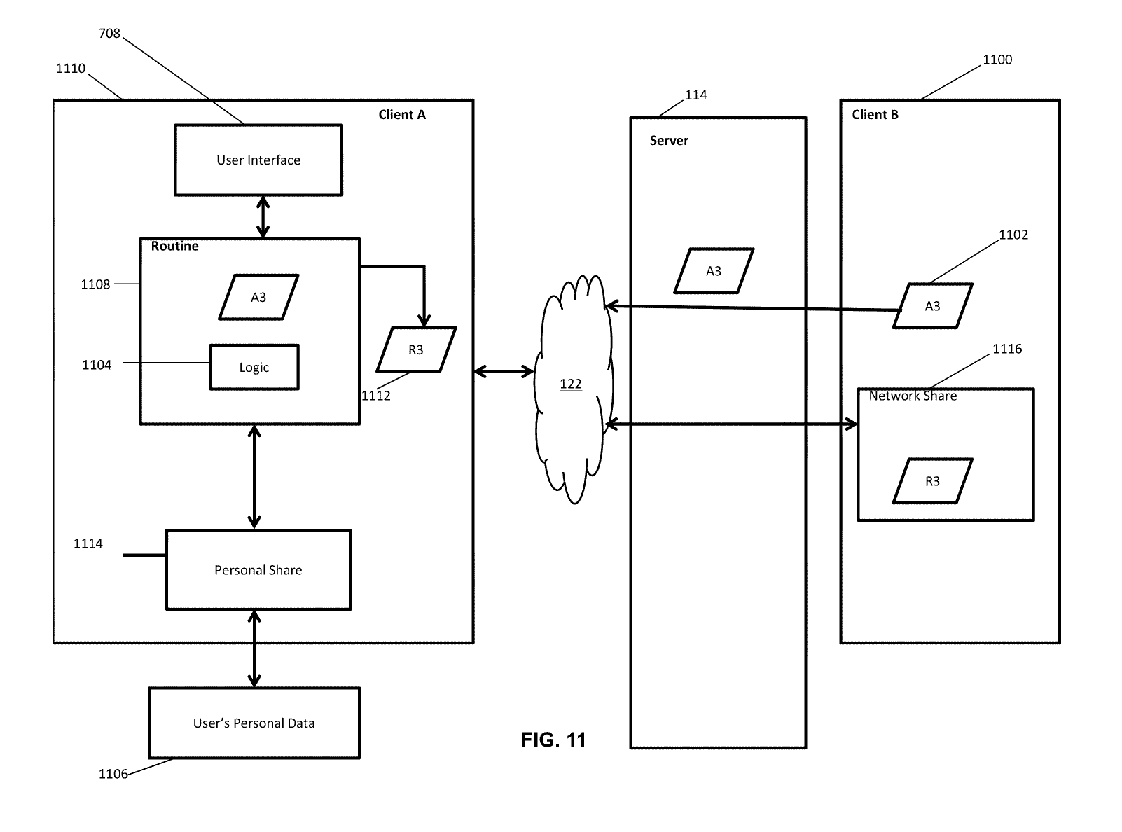

FIG. 11 illustrates a system for user configurable automatic client actions, according to some embodiments. The system includes a distributed server system 114, a user interface for approving the sharing of query output 708, a first local client system 1100, a directed query 1102, a logic for determining if a query can be run on a user's personal data 1104, personal data 1106, a routine for processing a query using the logic 1108, a second local client system 1110, query output 1112, processed personal data for sharing 1114, and user data for network sharing 1116.

A particular query 1102 is written by User B via User B's client 1100. For example, the query may be to ask trusted friends to find out the birthday of a John Gregory Smith from Albany, N.Y. The intention is for the query to be run (automatically or semi-automatically) on the personal data sets of trusted contacts to check if they are connected with John Gregory Smith of Albany, N.Y. and if so look for his birthday date.

The query may be sent via the server 114 to User A. The query is recognized by a routine 1108 running on User A's client 1110 that verifies that User B is a trusted contact of User A and that this automatic query can be run on User A's personal data 1106. It contains the logic that knows to check if John Gregory Smith from Albany, N.Y. is in User A's personal data, and then check if a birthday record for John Gregory Smith is there.

Alternatively, the query may be sent directly from User B's client to User A's client using peer-to-peer communication. For example, in some embodiments, User B's client may broadcast (e.g., via Bluetooth, Near Field Communication, WiFi, zero configuration networking, etc.) that it is willing to share news data with all users of the system. User A's client may use the same peer-to-peer protocol and broadcast a query requesting information about a traffic jam ahead of the user. When the User A's client comes in contact with the User B's client (e.g., within WiFi range), the query may be read by User B's client and all data it has that relates to the query is queued up for approval to be shared with the User A's client. In other embodiment, User B may not require approval before sharing any data to querying clients, and the response may be sent automatically.

The output 1112 of the query is shared with User B via the user interface 708. If approved by User A (if User A desires approval before an output leaves his client), the output is sent as a response 1112 via the server to User B. This infrastructure allows datasets across users to query one another and share data with the appropriate security permissions. It allows data present in one dataset to be available and useful to another dataset to accomplish a user's goal where a user's goal may be specific to a specific query such as finding a contact, or more general such as helping another user's data set receive any data that can help it become complete. It may facilitate an altruistic data sharing behavior where a user may be willing to anonymously share de-identified data that may help others, even strangers, accomplish their own objectives either directly, or through a network of users of which the said user is only one node.

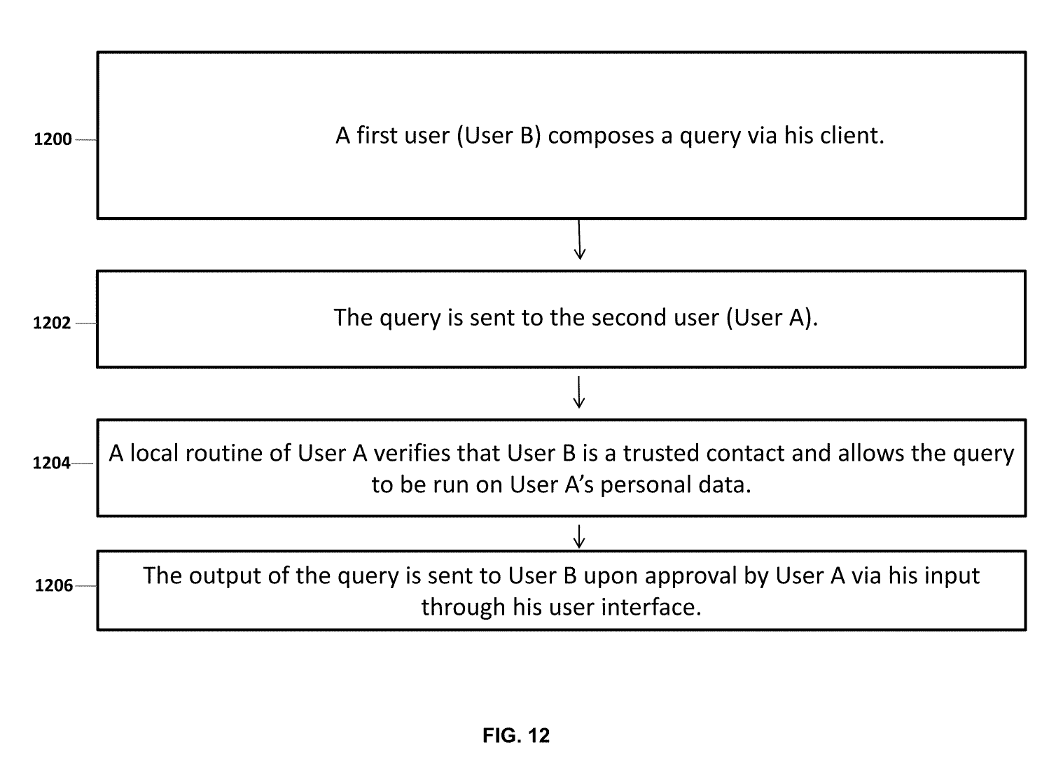

FIG. 12 illustrates a flow diagram of a process for user configurable automatic client actions, according to some embodiments. The process may include one or more of the steps of receiving a user query 1200, transmitting the user query to another user 1202, locally verifying that the originating user is a trusted contact of the receiving user to allow the query to be run on the receiving user's personal data 1204, and, upon approval by the receiving user, transmitting query output to the originating user 1206.

First, 1200, a query is written by a first user (e.g. User B) via his or her client. In some embodiments, a user may write a query through one or more of the following steps: (1) open the application, (2) enter query terms, and (3) select suggested related terms, (4) choose whether the query may be directed to someone specific or broadcasted to more than one person, (5) choose the data sources that should be accessed by a recipient's local client in running the query, and (6) choose whether the query may run automatically on the second user's client.

Next, 1202, the query is sent to a second user (e.g. User A). In some embodiments, the query may be sent to a second user through one or more of the following steps: (1) the second user is chosen by the first user, (2) the server determines whether the second user is allowing communications from the first user, and (3) the server recommends other known or unknown contacts relevant to the query that may be similar to the second user based on machine learning and data mining techniques to understand the query, applying the first user's communication patterns (if shared), and exploring the profiles of the other users.

Then, 1204, a routine running on the second user's client verifies that the first user is a trusted contact of the second user. In some embodiments, the second user's client may verify that the first user is a trusted contact through one or more of the following steps: (1) as a further level of security, a script running on the second user's client verifies that the first user is a trusted contact, and (2) the script may ask for a unique key given to the first user by the second user.

If the first user is verified, the query sent is processed automatically on the second user's personal data. In some embodiments, the query may be automatically processed through one or more of the following steps: (1) to prevent ‘rogue’ queries from running and disrupting user's data, the server first runs every query on simulated data, (2) those queries deemed to be safe are sent forward, (3) the safe query is received by the second user's client, (4) the query is run on data that is authorized for running of such queries (e.g., a query finding somebody's birthday by doing a quick lookup to see if the birthday data is present in the second user's data), (5) once the query is run, the results are shared with the second user for further iterations if desired, (6) the system learns about the second user's network graph based on what results are accepted and what iterations are done, and (7) the results are sent outside the second user's client (to the first user) with his or her explicit permission.

Finally, 1206, the second user may have set a preference to allow the output to be shared automatically with the first user, or only after the second user views the output and explicitly authorizes it to be shared with the first user. In some embodiments, the output of the query result may be shared by the second user through one or more of the following steps: (1) the client looks up the rules set by the second user to see if the result can be automatically shared with the first user, or is to first be reviewed by the second user, (2) the rule is followed, (3) the second user may add a personal note to the query result before it goes to the first user, (4) the system analyzes the second user's personal data to find contacts of the second user who are share interests, communication patterns, etc. with the first user, (5) using the user interface, the second user shares the query result with the first user and at times with others who share interests with the first user and are assumed to be appropriate co-recipients of the query result, and possibly (6) the second user pushes the query results and note to a public source on the system so that anybody can benefit from the query and its results.

The systems and methods describes in this disclosure may be illustrated by way of further examples, in accordance with some embodiments:

### Example 1

### High Efficiency Enterprise Sales

User A is interested in trying to sell an enterprise software system to Company X, but User A has not been able to find any contacts at Company X, neither in his own contact list, nor by searching publicly accessible social media like LinkedIn. User A knows User B, and User B happens to know User C, an employee at Company X, but User B is not an active social networking user, and this indirect relationship is unknown and previously unknowable to User A. Using the system described here, User A is able to capitalize on this indirect connection to Company X in an efficient way without compromising User B's privacy. See FIG. 1.

### Example 2

### Personalized Movie Recommendations

User A seeks movie recommendations from his network, but he does not know how to choose whom to ask. He wants to ask someone who may reply to him soon, with whom he has a close relationship, who shares his interest in movies and his predilection for sports. This system may enable him to do that easily, and even more powerfully, this system may enable him to identify some of his friends who are likely to share his taste in movies and then to directly query their movie-watching histories from Netflix, Amazon, Hulu, credit card statements, calendars, etc., to identify movies that these like-minded friends enjoyed and that he has not seen.

### Example 3

### Car Dealer Offers

A car dealer wants to respond to any request for information on the server that relates to cars so he can acquire new customers or serve existing customers. He listens to data coming to the server and makes his offer ‘pullable’ by interested users.

### Example 4

### Find a Restaurant

User A wishes to revisit seafood restaurants that she had enjoyed during a long car journey she is repeating after 2 years. She does not remember the names of the restaurants or where they are located, nor does she know if they are still open. Because her prior spending behavior is available through her current and past credit card statements, that information can be made available to her. Her credit card statements provide data on her transactions that allow the system to discover data on the restaurants she's visited using the following structure: restaurant.name, restaurant.amount, restaurant. date and restaurant.location.

### Example 5

### Find a Birthday

User A wants to find the birthday of John Gregory Smith from Albany, N.Y. He has common friends with John so hopes that one of his friends may know his birthday. He doesn't want to bother his friends and therefore sends an automatic query via the described system below.

### Example 6

### Find a Doctor

User A is looking for a surgeon for his father. He wants a surgeon who is experienced, skilled, highly recommended, and operates out of a particular city. His private data includes sufficient information to perform this search efficiently and accurately, but he wishes to know which contacts to ask based on the strength of his connection with the contacts and their relevance to the topic: recommending qualified surgeons.

### Example 7

### Collaborate with a Team

User A, User B, and User C all work as a team in the marketing department of a company. They are working together to organize a fundraising event. One of their objectives is to collect sponsorships for the event. User A is working on a sponsorship from Prospect X. User B went to college with Prospect X. The system allows User B's connection with Prospect X to be visible to User A. Further, it makes it simple for User A to automatically pull data on Prospect X from User B's database that has be authorized for sharing with the team. User C just met someone who works with Prospect X. User C updates each of the individual clients to allow them to pull this new data from User C's shared folder. The system allows not only sharing of data elements, but also it allows one client to change the state of data elements on the other client, for example, when User C has an update that she feels is very important to the team, she can change the color of the clients of A and B to red to get their attention.

### Example 8

### Find and Provide Feedback on Personalized Transportation Advice

User A is looking for directions from the airport in San Diego to the University of California San Diego. She wants information that she can trust and so she uses the system to ask relevant contacts. She first identifies the right people to ask, and then sends them a message to request for their advice. In one embodiment she sends the message as a common message that all recipients can see; they can see the responses as well to learn when her query has been satisfactorily addressed. In a further embodiment, when she actually navigates from the airport to the university, she shares her geocoordinates via the system in real time to those who helped with her query. They can view and participate in her experience, and see first-hand that their advice was effective and used. In another embodiment, she shares the responses that she received from her contacts as a data object that is available off the server to anyone requesting similar information

### Example 9

### Find an Office Confidentially

User A wishes to rent an office in Cambridge, Mass., for his growing business, but he does not want to alert his competition that he is opening an office in the area. His goal is guidance from trusted and knowledgeable people to lead him ultimately to a rental agreement. He knows a number of appropriate leads including people who live or have lived in Cambridge, Mass., work or have worked there, are in the real estate business, are connected to people in the real estate business and so on. He further wants to work through only those people he feels he can trust very highly, or have a low likelihood of having worked with his competitors.

### Example 10

### Corporate Knowledge Discovery

User A and User D work at the same company. User A is working on a technical Problem P that User D has encountered before, and has recorded in one of his time sheet reports. Further, User D has files on his computer that relate to Problem P. User D has also communicated with others within the company on Problem P through the company's internal email/chat system. As User A starts to work on Problem P, the system discovers these valuable sources of data for him. The system also brings in data from public sources such as discussions on a technical forum that has focused on issues related to Problem P with high activity, published technical reports that relate to Problem P, news reports, product reviews, online courses, and other external data that relate to Problem P. The discovery of this knowledge helps User A leverage the efforts already exerted on Problem P within his company along with external data relevant to solve Problem P.

### Example 11

### Share Collaborative Resources

User A wants to share all of the digital photographs that he captured along with his friend User E during a one-week vacation they took together last summer. The system recognizes that Users A and E were together while these photographs were captured based on geospatial data, image recognition, data shared by both of their cameras, or other means. User A has indicated to the system to share all ‘collaborative resources’ he has with User E where they both may have contributed to the generation, collection, refinement, or use of data objects. The system tags the photographs as collaborative resources, learns from ways in which User A may edit those tags, and gives User E the ability to pull the resources to his own client.

### Example 12

### Pull Back Shared Resources

User A has shared ‘collaborative resources’ with User E. A system tag that can be assigned to each data object may define the ‘owner’ of the data object. One of the collaborative resources that User A has shared is a prize photograph he had taken of Mount McKinley. User A has submitted the photograph for publication in a magazine and wishes to give assurance that the photograph may not be reproduced through any other channels. He uses the system to pull all of the data objects owned by him that he's shared with User E. Further, once resources are pulled back, the resources won't display or run on any system associated applications except those with appropriate permissions.

### Example 13

### Explore Public Communication

User A has a friend User F who uses a number of communication channels (email, text messaging, social networking sites, discussion boards, etc.). Some are private and others public. User A may like to keep updated on User F's public communication. He can conventionally track those channels directly with each of the primary sources (for example, the social networking website, discussion board, etc.). However, finding User F on each of those sites or channels can be time consuming, especially since a priori User A doesn't know if he'd find User F on any, some, or all of the channels. Further, only User F may be able to tell User A which of the channels are the most worthwhile to follow. Some of the channels, for example, may be used by him for commercial promotion, and may not interest User A. Through the system, User F can specify his active public channels that he'd like to promote by providing their handles or identifiers. This design allows User A to have a high signal to noise ratio in finding relevant public communication made by his friend. He can deploy filters to further control the frequency and type of communication he'd like to view through the system. It is a more transparent way for User A to access data on User F—directly through User F, and not through other means that can appear furtive.

### Example 14

### Buying Clothes for a Friend

User A wants to purchase a jacket for a friend but he doesn't know his size. Through the system his friend has shared his detailed dimensions (as numbers, a realistic graphical representation of his body, or other) and preferred styles, but as he is very private, his data is encrypted. When User A goes shopping (online, in a store, or through an agent), his client pulls the encrypted data off the system and provides it to the retailer that has an approved key to decrypt the dimensions and styles. The retailer simulates how the available jackets may fit User A's friend based on the decrypted data and provides a numerical output (for example, margins of error around an acceptable fit and style) or a graphical output (for example, an image of his friend wearing the jacket). The retailer also offers to create tailored clothes based on the decrypted data. User A is satisfied that the jacket he chose has a size and style that may be acceptable to his friend, and he purchases it, earning a commission for system.

### Example 15

### Share Personal Information Securely and Anonymously

User A wants to purchase a car. He has stored his credit report on a shared folder on his client. It is encrypted and anonymized. He sends an open query to purchase a sports utility vehicle to the server that is received by a number of car companies that have subscribed. The subscribing car companies have been approved by the system and so receive an encryption key which enables them to read User A's anonymized credit report. Based on his credit report, two companies send back a deal on a new vehicle. User A reviews the two of them, communicates a few times with the companies, and finalizes on one of the options. The system enables him to complete this complex transaction in a secure and anonymous way. It also provides him a way to share non-sensitive elements of his transaction via the server to benefit others in the same pursuit.

### Example 16

### Decomposing data

A user's credit card statements can be loaded into the system and deconstructed into its metadata components so while privacy is maintained, its components (such as his most commonly visited cities) can be usefully applied towards queries.

### Example 17

### Knowledge discovery

User A's private data may include web pages he has visited, emails he has received, or other such content further explicitly shared by him with his client device. In this example, User A's intention is to search for knowledge on “iron ore.” Features extracted through machine learning or other data analysis techniques on his private data provides the insight that User A is most likely interested in “iron ore” as it relates to investment activities, and in the South East Asia region of the world. The system has applied machine learning or other data analysis techniques to map public sources to determine that particular mailing lists, blogs, and websites are highly reliable sources for knowledge on topics such as “iron ore.”

When User A sends a directed query on “iron ore,” the query is sent to those relevant public sources, and a greater weighting for returned results is given for content that relates to the South East Asia region.

User A further has the ability through his user interface to visualize this returned content as a snapshot, observe as it evolves over time, and provide feedback on relevance and his interest on the specific content items he sees. The interface may also display elements from his private data such as names and professional details of his contacts that become relevant to the returned content. For example, one such displayed contact may be a friend of User A who works in the mining ministry in a country that does significant trade with South East Asia.

A client device may be dedicated to User A and perform this search continuously and recursively to improve the relevance of the content he can visualize in real-time through his user interface for knowledge discovery.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor may receive instructions and data from a read only memory or a random access memory or both. The essential elements of a computer are a processor for executing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

We claim:

1. A method of transmitting a directed query from a client device storing private data elements, the method comprising:
determining a plurality of relationships between elements of the private data, wherein each relationship of the plurality of relationships associates two or more elements of the private data;
receiving a query related to a target element of the private data, wherein the query requests data related to the element, wherein the data related to the element is not present in the private data;
storing the query in electronic memory;
based on the relationships associated with the target element of the query, determining a recipient for the query; and
electronically transmitting the query to the recipient.

2. The method of claim 1, wherein a weight is determined for each relationship of the plurality of relationships, wherein the weight of each relationship indicates a degree of connection between the two or more elements associated by the relationship.

3. The method of claim 2, wherein the weight determined for each relationship of the plurality of relationships is used, at least in part, to determine the recipient for the query.

4. The method of claim 2, wherein the elements comprise users and the weight indicates at least one of frequency of interaction between the users and rate of change of frequency of interaction between the users.

5. The method of claim 2, wherein the weights are determined based, at least in part, on the target element of the query.

6. The method of claim 1, wherein the private data includes at least one of contact lists, email histories, messaging histories, web browsing histories, and social networking histories.

7. The method of claim 1, wherein the recipient comprises at least one of a second client device and a search engine server.

8. The method of claim 1, further comprising receiving an anonymous identifier, wherein transmitting the query to the recipient comprises associating the transmission with the anonymous identifier.

9. The method of claim 1, wherein determining a recipient for the query comprises receiving one or more recipients in response to a request for relevant recipients.

10. The method of claim 1, wherein the client device transmits the query to the recipient using a network connection of the client device.

11. The method of claim 1, further comprising:
obtaining, using a network connection of the client device, public data elements from an external server, wherein the public data elements relate to the target element of the query; and
providing a response to the query based on the relationships associated with the target element of the query, the private data elements, and the public data elements.

12. The method of claim 11, further comprising:
receiving feedback describing a degree of relevance of the response; and
refining the response based on the degree of relevance of the response.

13. A client device comprising:
one or more interfaces configured to transmit a directed query to one or more of a plurality of recipients;
a memory for storing private data elements; and
a processor configured to:
determine a plurality of relationships between elements of the private data, wherein each relationship of the plurality of relationships associates two or more elements of the private data;
receive a query related to a target element of the private data, wherein the query requests data related to the element, wherein the data related to the element is not present in the memory for storing private data elements;
based on the relationships associated with the target element of the query, determine a recipient for the query; and
using the one or more interfaces, transmit the query to the recipient.

14. The client device of claim 13, wherein the processor is further configured to determine a weight for each relationship of the plurality of relationships, wherein the weight of each relationship indicates a degree of connection between the two or more elements associated by the relationship.

15. The client device of claim 14, wherein the processor is further configured to use the weight determined for each relationship of the plurality of relationships, at least in part, to determine the recipient for the query.

16. The client device of claim 14, wherein the elements comprise users and the weight indicates at least one of frequency of interaction between the users and rate of change of frequency of interaction between the users.

17. The client device of claim 14, wherein the processor is further configured to determine the weights based, at least in part, on the target element of the query.

18. The client device of claim 13, wherein the private data includes at least one of contact lists, email histories, messaging histories, web browsing histories, and social networking histories.

19. The client device of claim 13, wherein the recipient comprises at least one of a second client device and a search engine server.

20. The client device of claim 13, wherein the processor is further configured to receive an anonymous identifier and, when transmitting the query to the recipient, to associate the transmission with the anonymous identifier.

21. The client device of claim 13, wherein the processor is further configured to determine a recipient for the query by receiving one or more recipients in response to a request for relevant recipients, wherein the request is transmitted using the one or more interfaces.

22. The client device of claim 13, wherein the processor is further configured to:
obtain, using the one or more interfaces, public data elements from an external server, wherein the public data elements relate to the target element of the query; and
provide a response to the query based on the relationships associated with the target element of the query, the private data elements, and the public data elements.

23. The client device of claim 22, wherein the processor is further configured to:
receive feedback describing a degree of relevance of the response; and
refine the response based on the degree of relevance of the response.
